(19) United States
(12) Patent Application Publication
(10) Pub. No.: US 2003/0014300 A1
(43) Pub. Date: Jan. 16, 2003

(54) Method and apparatus for managing workplace employee charitable giving campaigns

(76) Inventors: Mary Franco, New Canaan, CT (US); Elizabeth Gregory, Darien, CT (US); Jonathan Schwartz, Monroe, CT (US)

Correspondence Address: BUCKLEY, MASCHOFF, TALWALKAR, & ALLISON, 5 ELM STREET, NEW CANAAN, CT, 06840, US

(21) Appl. No.: 10/074,697

(22) Filed: Feb. 12, 2002

Related U.S. Application Data
(60) Provisional application No. 60/305,270, filed on Jul. 13, 2001.

(51) Int. Cl. G06F 17/60

(52) U.S. Cl. 705/10

(57) ABSTRACT

A system, method, apparatus, computer program code, and means is provided for structuring an automated charitable contribution program at an entity consisting of a plurality of operating units. The charitable contribution program includes establishing a program hierarchy including at least one campaign manager and at least one canvasser for each of the operating units. Information identifying a plurality of potential donors is retrieved information and each of the potential donors is associated with a canvasser. A personalized information screen for each of the potential donors is generated.

### CROSS REFERENCE TO RELATED APPLICATIONS

The present application claims the benefit of U.S. Provisional Patent Application Serial No. 60/305,270 entitled “METHOD AND APPARATUS FOR MANAGING WORKPLACE EMPLOYEE CHARITABLE GIVING CAMPAIGNS” and filed on Jul. 13, 2001. The entire content of this provisional application is incorporated herein by reference.

### FIELD OF THE INVENTION

The present invention relates to methods and apparatus for charitable programs. More particularly, the present invention relates to methods and apparatus for managing charitable contribution programs.

### BACKGROUND OF THE INVENTION

Workplace giving programs and organized charitable campaigns comprise a very large portion of charitable contributions each year. For example, one popular charitable campaign run in the United States is the United Way campaign. In 1999-2000, United Way volunteers raised approximately $3.77 billion dollars. The United Way is formed of a large number of local United Way chapters serving local charities. Each year, many corporations and communities participate in United Way fund drives by encouraging employees and individuals to contribute to United Way charities. Other large-scale campaigns also exist, such as the Combined Federal Campaign (CFC), an annual fund-raising drive conducted by Federal employees in their workplace each fall. Each year Federal employees and military personnel raise millions of dollars through the CFC that benefits thousands of non-profit charities.

Running these campaigns is a complex undertaking, particularly for large organizations. Several considerations, often conflicting, complicate the undertaking. A first consideration is the need for the corporation to have up-to-date, accurate and reliable information about the status of the campaign. This is complicated by the fact that many corporations have multiple, geographically separate operating units each of which may be operating different local campaigns. A second consideration is the need to actively and efficiently solicit contributions from employees and other potential donors. In the past, this has been done by appointing individuals as canvassers to be responsible for a group of potential donors. It can be difficult for these canvassers to keep track of the status of their potential donors and to disseminate information regarding the campaign to the potential donors.

A number of companies have attempted to automate aspects of their corporate giving programs. A summary of such automation is set forth in “E-Campaigning: Using Technology in the Annual United Way Campaign; A Guide To Best Practices” published by the United Way of America in 2000. Each of these automated programs appear to be intended to provide centralized management of corporate giving programs. The systems also appear to automate the actual pledge process. Unfortunately, none of these automated programs appear to satisfy both of the considerations described above (allowing centralized reporting and oversight in connection with the distributed and personalized interaction between fundraisers and potential donors).

It would be advantageous to provide a method and apparatus that overcame the drawbacks of existing systems. In particular, it would be desirable to provide a system which allows an entity to run a charitable contribution program across multiple operating units with a large number of participants in an efficient, reliable and accurate manner. Further, it would be desirable to provide a system and method which allows centralized control of reporting and establishment of program objectives with decentralized control over fundraising and solicitation of contributions from individual participants.

### SUMMARY OF THE INVENTION

To alleviate the problems inherent in the prior art, embodiments of the present invention provide an efficient and effective system and a method for operating a charitable contribution program.

In one embodiment, a method, apparatus and computer program code is provided for structuring an automated charitable contribution program at an entity consisting of a plurality of operating units. A program hierarchy is established including at least one campaign manager and at least one canvasser for each of the operating units. Information identifying a plurality of potential donors is retrieved and each of the potential donors is associated with a canvasser. A personalized information screen for each of the potential donors is generated.

According to one embodiment, the program hierarchy is established by granting special access privileges to each of the participants, including the campaign manager, the canvassers and the potential donors. According to one embodiment, information screens are also generated for the campaign manager and the canvassers, the information screens facilitating interaction between each of the participants.

According to another embodiment of the present invention, a method, apparatus and computer program code for conducting an automated charitable contribution program in an entity having a number of operating units is provided. Donation solicitation information is transmitted to a plurality of potential donors at each of the operating units and receiving donation information from at least one of the plurality of potential donors. A pledge database is then updated, substantially in real time in response to receiving donation information.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a flow diagram depicting a method of managing a charitable program pursuant to one embodiment of the present invention;

FIG. 2 is a block diagram of a system for managing a charitable program pursuant to an embodiment of the present invention;

FIG. 3 is a block diagram of an embodiment of the controller of the system of FIG. 2;

FIG. 4 is a block diagram of an embodiment of the user device of the system of FIG. 2;

FIG. 5 is a table depicting an exemplary employee database used in the system of FIG. 2;

FIG. 6 is a table depicting an exemplary local campaign database used in the system of FIG. 2;

FIG. 7 is a table depicting an exemplary campaign database used in the system of FIG. 2;

FIG. 8 is a table depicting an exemplary donation database used in the system of FIG. 2;

FIG. 9 is a flow diagram depicting a method of defining a charitable program pursuant to one embodiment of the present invention;

FIG. 10 is a flow diagram depicting a method of conducting a charitable program pursuant to one embodiment of the present invention;

FIGS. 11A-F are user interface diagrams depicting example user interfaces used in an embodiment of the present invention; and

FIG. 12 is an example hierarchy of a campaign conducted pursuant to the present invention.

### DETAILED DESCRIPTION OF THE INVENTION

Applicants have recognized that there is a need for automated systems and methods which assist entities in the management of charitable contribution programs. In particular, Applicants have recognized that there is a need for systems which provide centralized control.

A number of terms are used herein to facilitate understanding of features of embodiments of the invention. As used herein the term “entity” will be used to refer to an entity donating and soliciting donations to charities in a charitable campaign. The entity may be, for example, a corporation, an affinity group, a governmental agency or group, or any other association of individuals which has a desire to organize a fund drive to benefit charities through a charitable campaign. Throughout this disclosure, a preferred embodiment will be described which involves a corporation having multiple divisions or “operating units”. Those skilled in the art will recognize that this is simply an example, and that other types of entities may also benefit from embodiments of the present invention.

As used herein, the term “charitable contribution program” will be used to refer to an organized effort by an entity to solicit donations to one or more charities via a charitable campaign. The “charitable campaign” may be any of a number of established charitable campaigns (such as the United Way or the Combined Federal Campaign) or it may be one established by the entity on its own (e.g., by selecting one or more charitable organizations for which contributions will be solicited). An entity's charitable contribution program may have a pre-established start and end date selected to correspond to the start and end date of a charitable campaign.

As used herein, the term “local campaign” is used to refer to regional campaigns which are part of the overall charitable campaign. For example, the “charitable campaign” may be a nation-wide or world-wide campaign consisting of a number of “local campaigns” which are subsets of the overall charitable campaign. In this manner, potential donors in different regions can direct contributions (via the local campaign) to locally-relevant charities.

As used herein, the terms “global campaign manager”, “champion”, “captain” and “canvasser” are used to refer to particular individuals operating together to conduct a charitable giving campaign pursuant to embodiments of the present invention. These individuals and the functions they perform may be referred to by any of a number of different labels (e.g., a “champion” may be referred to as a local campaign manager or any other title). The labels of these participants are not intended to be limiting of embodiments of the present invention. For example, in a campaign operated by an entity having a plurality of operating units, the “global campaign manager” may be the overall campaign leader, the “champions” may be individuals responsible for each operating unit, the “captains” may be intermediate level managers reporting to the “champions”, and individual “canvassers” may report to the captains and may be responsible for soliciting contributions from individual employees.

As used herein, the terms “donor” and “potential donor” may be used interchangeably with the term “employee” in describing a preferred embodiment where the entity is a corporation and the potential donors (and actual donors) are employees of the corporation. Those skilled in the art will recognize that other donors and potential donors (including non-employees) may also benefit from use of embodiments of the present invention.

System

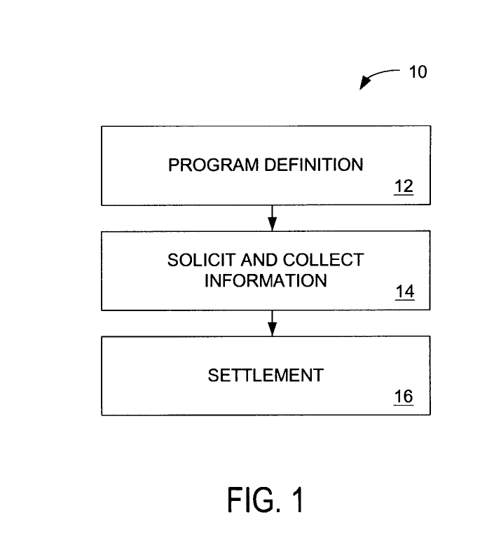

Referring now to FIG. 1, a process 10 for managing a charitable contribution program pursuant to one embodiment of the present invention is shown. In one embodiment, process 10 may be managed by or on behalf of a corporation or other organization which desires to operate and manage a charitable contribution program for its employees or other individuals.

Processing begins at 12, where the entity performs charitable contribution program definition activities, including the identification of the charitable campaign (e.g., the charitable campaign may be an established campaign such as the 2001 United Way Campaign) associated with the entity's charitable contribution program. A global campaign manager to lead the entity's charitable campaign efforts is also selected at this time. Typically, entities such as corporations select a relatively senior manager to perform this role. As will be discussed, embodiments of the present invention enable this campaign manager to establish a campaign hierarchy and to manage the campaign hierarchy efficiently through the use of computers and other technology.

Processing at 12 may also involve the identification of one or more local campaigns which are a subset of the overall charitable campaign. In one embodiment, this is done in an automated fashion using the system of the present invention to associate local campaigns with different operating units of the corporation in different locations. According to one embodiment of the invention, these local campaigns may be automatically matched with individual operating units of an entity by comparing geographical information associated with each of the operating units with geographical information associated with each of the local campaigns.

Other charitable contribution program definition activities may also be performed at 12, including the establishment of a program management hierarchy. In one embodiment, the entity operating a charitable contribution program first selects an individual to run the charitable contribution program (the “global campaign manager”). The global campaign manager then takes steps to identify and appoint one or more individuals as middle managers of the program (referred to herein as the “champions” and “captains”). The global campaign manager (or the captains or champions) then utilize the system of the present invention to select and appoint a number of individuals as the day-to-day solicitors of the program (referred to herein as the “canvassers”). Unlike existing systems which are designed to support charitable campaigns, embodiments of the present invention create hierarchies which facilitate electronic interaction and communication between each of these individuals.

According to one embodiment, these hierarchies are enforced and maintained through the grant of different access privileges and permissions. For example, according to one embodiment of the present invention, a global campaign manager is given higher system privileges than a champion, who has a higher system privilege than a captain, who in turn receives higher privileges than a canvasser. The different access privileges allow the establishment of a hierarchy which facilitates information exchange, program management, and communication between individuals, leading to the conduct of a more efficient, cost effective and successful charitable contribution program.

In connection with the establishment of a hierarchy and the granting of various access and usage permissions, embodiments of the present invention also involve the generation of one or more information screens accessible by each of the participants. These information screens are created to be accessible, for example, by users operating devices having a Web-browser (such as Microsoft's Internet Explorer® or Netscape's Navigator®) and viewing one or more Web-pages established by the system for access by each of the participants. Further details regarding these information screens and different access privileges for different participants will be presented below. Information exchanged and received using these information screens can be encrypted or otherwise protected using techniques known to those skilled in the art.

Processing at 12 may also include the identification of participating employees (potential donors) in the charitable contribution program. In one embodiment, this is done using existing data sources such as, for example, a corporation's payroll or employee database. In other embodiments, this may involve the creation of one or more new databases or listings of employees. According to one embodiment of the invention, the identification of potential donors also includes grouping potential donors by organization or operating unit. This allows the automatic identification of the appropriate local campaign in which a potential donor will be participating. Further, this facilitates selection of one or more captains and canvassers for a particular group of potential donors.

Processing at 12 may also involve the establishment of one or more charitable campaign goals by the campaign manager and champion. For example, campaign goals may be established in relation to the entity's charitable giving performance the prior year or based on other objectives of the entity. Other activities which may occur during a charitable contribution program definition phase will be described below.

Once a particular charitable contribution program has been defined, processing continues to 14, where the system of the present invention is operated to solicit and collect information from potential donors. In one embodiment, this solicitation and collection from potential donors is done in a large part on-line using the system of the present invention. In particular, donations are solicited from potential donors by presenting donation request information in an information screen created for each potential donor. This information screen may include, for example, prior donation history for the donor, and one or more personalized messages from the canvasser, captain, champion and/or campaign manager associated with the potential donor.

These information screens are further adapted to facilitate communication between each potential donor and their assigned canvasser, captain, champion and/or campaign manager. This convenient and interactive information exchange allows an appropriate level of human contact and interaction between all participants in a campaign. Further, this permits the creation and management of a charitable contribution program which is centrally monitored but which has distributed control over the solicitation and generation of pledges.

At 14, information regarding donations is also collected. In one embodiment, pledges may be made by potential donors by interacting with information screens generated for each potential donor. In one embodiment, each information screen for potential donors presents a number of different donation options for the potential donor, including options regarding payment and options regarding the identification and selection of donees.

Processing at 14 continues until the charitable contribution program is completed. According to the invention, information collected at FIG. 14 is collected substantially in real time. Information from multiple organizations or operating units are collected, allowing an entity with multiple operating units to have up-to-date and accurate information about the status of a charitable contribution program or a particular campaign across multiple operating units.

Processing continues at 16 where settlement occurs. In one embodiment of the present invention, settlement occurs in a batch process in several different batches. For example, in one embodiment, a first batch is transmitted from the entity to a charitable organization (such as, for example, the United Way or Combined Federal Campaign), transmitting pledge information from the entity to the charitable organization. The funding of the pledges identified in the pledge information may occur in multiple batches. For example, in one embodiment, a regular payroll deduction may occur and funds withheld from employee's payroll are then transmitted to designated charities (e.g., via check or electronic funds transfer techniques). Settlement at 16 and the solicitation and collection of information at 14 may be done in an iterative fashion until the campaign is complete, at which time some continuing settlement may occur, but no further pledges may be received. Other features of this settlement process will be discussed further below.

The result is an automated system allowing an entity to efficiently and productively manage a charitable contribution program. In particular, embodiments of the invention permit an entity to centrally manage a charitable contribution program while distributing control over day-to-day solicitation activities.

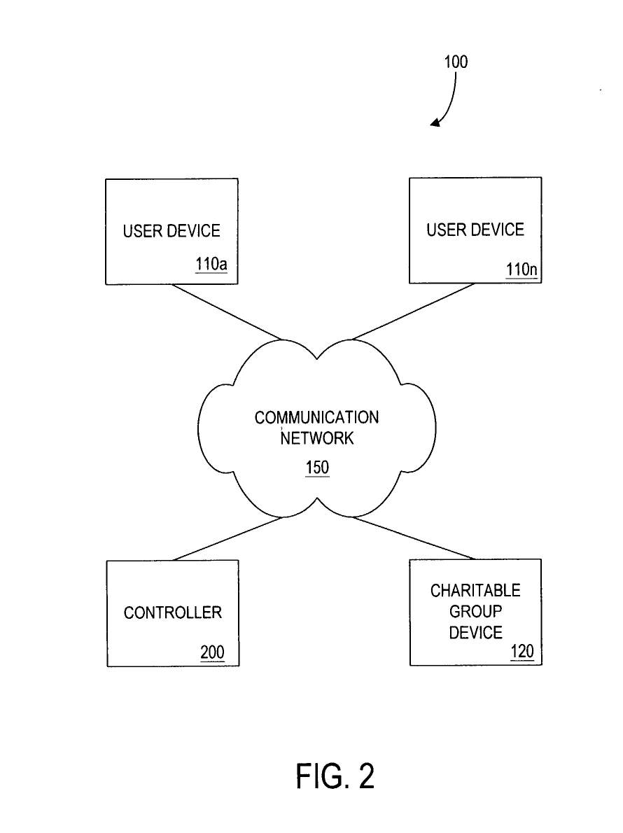

Embodiments of the present invention will now be described in greater detail by referring first to FIG. 2, where a system 100 for managing a charitable contribution program is shown. According to one currently-preferred embodiment, system 100 is a network of computers and other devices, some of which are operated by, or on behalf of, an entity operating a charitable contribution program using techniques of the present invention. A number of devices operated by, or on behalf of, the entity are in communication with each other via a communications network 150. These devices, which are operated by or on behalf of the entity, include a plurality of user devices 110a-n which are operated by individuals (including individuals appointed as a campaign manager, champion, captain, canvasser, or donor) interacting with the system in various capacities which will be discussed below.

One or more controllers 200 may also be operated by or on behalf of the entity as well. Controller 200, as will be described further below, includes functionality and stores or otherwise accesses data necessary to achieve the functionality of the present invention. In one embodiment, controller 200 is configured as a World Wide Web (“Web”) server, storing data and programs accessible by other devices (including user devices 110) via communication network 150. In one currently preferred embodiment, each of the devices are configured with Web-browsers allowing the display and interaction of data using Internet-compatible protocols.

Other devices in communication via network 150 include devices operated by third parties. For example, charitable group devices 120 operated by or on behalf of one or more charitable groups (e.g., the United Way or similar charitable organizers or individual charities) may be in communication with other devices of system 100 via network 150.

As used herein, devices (such as user devices 110a-n, controller 200, and charitable group device 120) may communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology. In one preferred embodiment, user devices 110a-n and controller 200 are connected to an entity's corporate network.

User devices 110a-n, controller 200 and charitable group devices 120 may be any devices capable of performing the various functions described herein. The devices may be implemented as, for example: a Personal Computer (PC), a portable computing device such as a Personal Digital Assistant (PDA), a wired or wireless telephone, or any other appropriate storage and/or communication device.

Note that although a single controller 200 is shown in FIG. 2, any number of controllers 200 may be included in system 100. Similarly, any number of the other devices described herein may be included in system 100 according to embodiments of the present invention. For example, an entity may run charitable contribution programs benefiting a number of different charitable groups or participate in a number of charitable campaigns, in which case system 100 may facilitate communication with a number of charitable group devices 120.

Devices

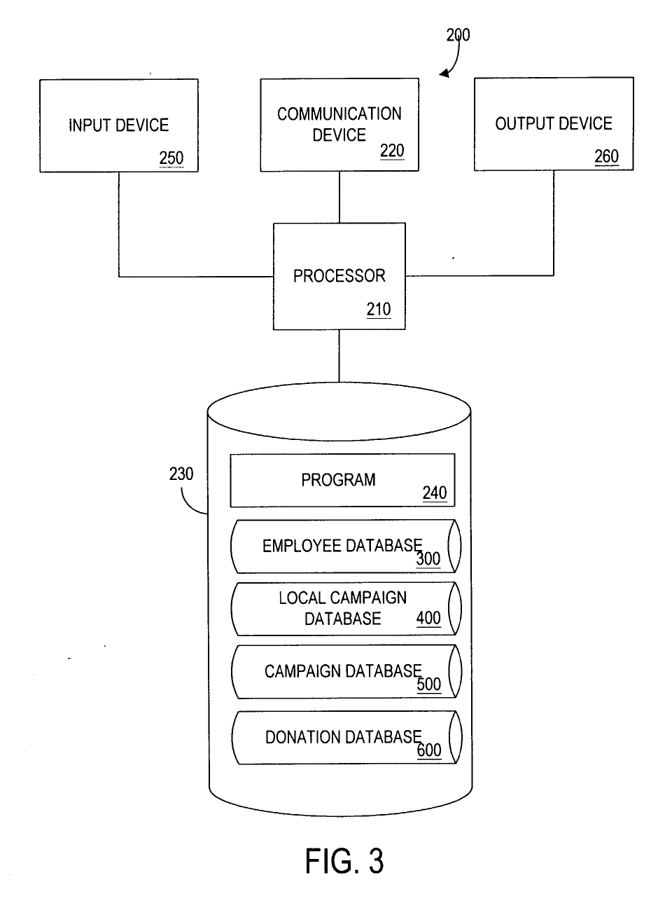

FIG. 3 illustrates an embodiment of controller 200. Controller 200 may be implemented as a system controller, a dedicated hardware circuit, an appropriately programmed general purpose computer, or any other equivalent electronic, mechanical or electro-mechanical device.

Controller 200 comprises a processor 210, such as one or more Intel® Pentium® processors. Processor 210 is coupled to a communication device 220 through which processor 210 communicates with other devices, such as, for example, one or more user devices 110. Communication device 220 may include hardware and software facilitating communication with other devices using wired or wireless techniques, or a combination of different techniques. For example, communication device 220 may be one or more of: a network adapter, a modem, a Bluetooth chip, etc.

Processor 210 is also in communication with an input device 250. Input device 250 may comprise, for example, a keyboard, a mouse or other pointing device, a microphone, a knob or a switch (including an electronic representation of a knob or a switch), an infrared port, a docking station, and/or a touch screen. Processor 210 is also in communication with an output device 260. Output device 260 may comprise, for example, a display (e.g., a computer monitor), a speaker, and/or a printer.

Processor 210 is also in communication with a data storage device 230. Data storage device 230 comprises an appropriate combination of magnetic, optical and/or semiconductor memory, and may include, for example, Random Access Memory (RAM), Read-Only Memory (ROM), a compact disc and/or a hard disk. Processor 210 and data storage device 230 may each be, for example: (i) located entirely within a single computer or other computing device; or (ii) connected to each other by a remote communication medium, such as a serial port cable, telephone line or radio frequency transceiver. In one embodiment, controller 200 may comprise one or more computers that are connected to a remote server computer for maintaining databases.

Data storage device 230 stores a program 240 for controlling processor 210. Processor 210 performs instructions of program 240, and thereby operates in accordance with the present invention, and particularly in accordance with the methods described in detail herein. Program 240 may be stored in a compressed, uncompiled and/or encrypted format. Program 240 furthermore includes program elements that may be necessary, such as an operating system, a database management system and “device drivers” for allowing processor 210 to interface with computer peripheral devices. Appropriate program elements are known to those skilled in the art, and need not be described in detail herein.

According to an embodiment of the present invention, the instructions of program 240 may be read into a main memory from another computer-readable medium, such as from a ROM to RAM. Execution of sequences of the instructions in program 240 causes processor 210 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

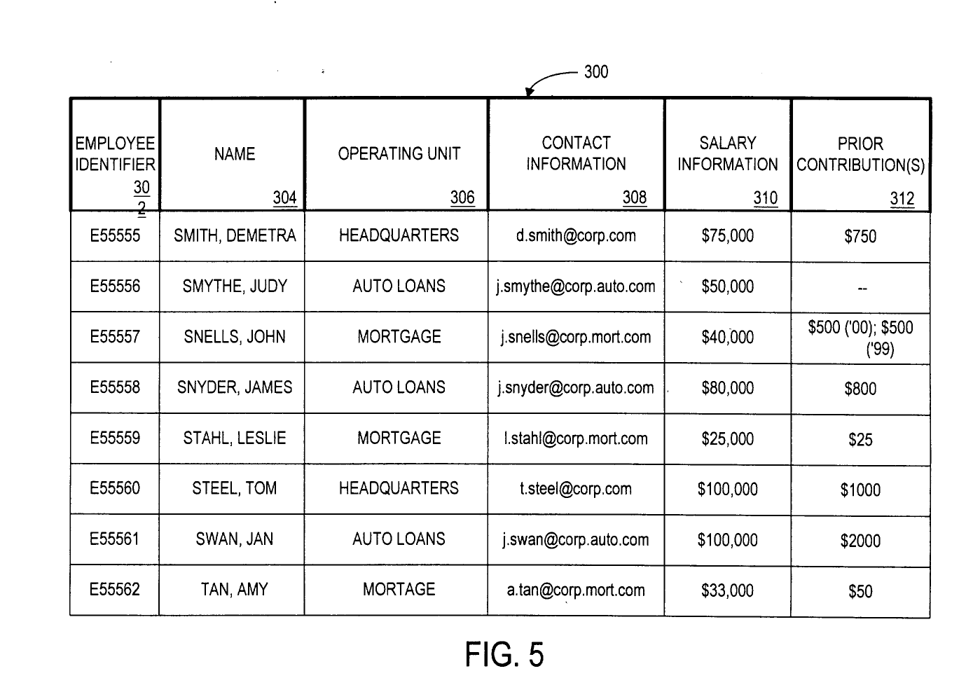

Data storage device 230 also stores (or has access to) (i) an employee database 300, (ii) a local campaign database 400, (iii) a campaign database 500, and (iv) a donation database 600. The databases 300, 400, 500, and 600 are described in detail below and depicted with exemplary entries in the accompanying figures (FIGS. 5-8 below). As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

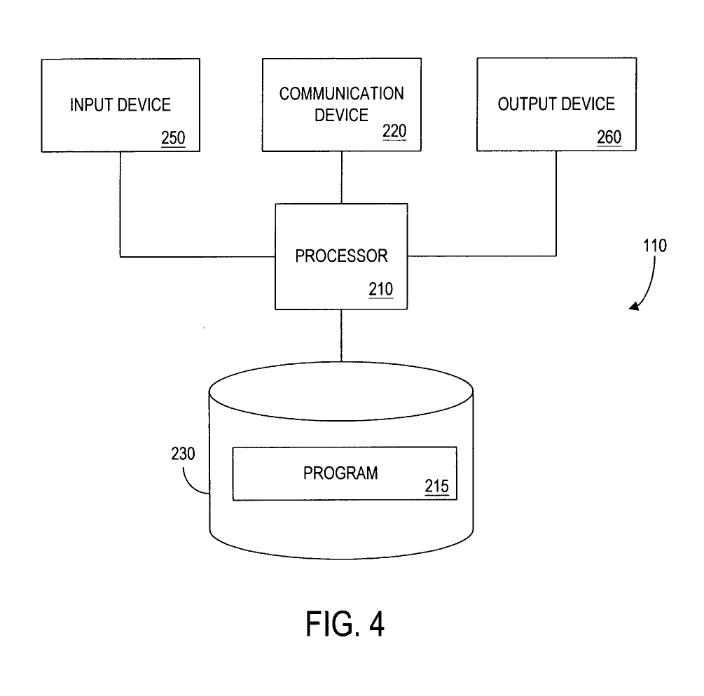

FIG. 4 illustrates an embodiment of user device 110. User device 110 may be implemented as a personal computer, a PDA, a dedicated hardware circuit, an appropriately programmed general purpose computer, or any other equivalent electronic, mechanical or electro-mechanical device. Different configurations of user devices 110 may be used in system 100 (for example, some users may interact with the system using desktop PCs, while others may interact with the system using PDAs, smart telephones, or the like).

User device 110 comprises a processor 210, such as one or more Intel® Pentium® processors. Processor 210 is coupled to a communication device 220 through which processor 210 communicates with other devices, such as, for example, one or more 300. Communication device 220 may include hardware and software facilitation communication with other devices using wired or wireless techniques, or a combination of different techniques. For example, communication device 220 may be one or more of: a network adapter, a modem, a Bluetooth chip, etc.

Processor 210 is also in communication with an input device 250. Input device 250 may comprise, for example, a keyboard, a mouse or other pointing device, a microphone, a knob or a switch (including an electronic representation of a knob or a switch), an infrared port, a docking station, and/or a touch screen. Such an input device 250 may be used, for example, by a potential donor to interact with a canvasser assigned to interact with the potential donor or to otherwise input information or make selections within the charitable contribution program.

Processor 210 is also in communication with an output device 260. Output device 260 may comprise, for example, a display (e.g., a computer monitor), a speaker, and/or a printer. Output device 260 may be used, for example, to display charitable program information to a user such as a potential donor.

Processor 210 is also in communication with a data storage device 230. Data storage device 230 comprises an appropriate combination of magnetic, optical and/or semiconductor memory, and may include, for example, Random Access Memory (RAM), Read-Only Memory (ROM), a compact disc and/or a hard disk. Processor 210 and data storage device 230 may each be, for example: (i) located entirely within a single computer or other computing device; or (ii) connected to each other by a remote communication medium, such as a serial port cable, telephone line or radio frequency transceiver. In one embodiment, user device 110 may comprise one or more computers that are connected to a remote server computer for maintaining databases.

Data storage device 230 stores a program 215 for controlling processor 210. Processor 210 performs instructions of program 215, and thereby operates in accordance with the present invention, and particularly in accordance with the methods described in detail herein. Program 215 may be stored in a compressed, uncompiled and/or encrypted format. Program 215 furthermore includes program elements that may be necessary, such as an operating system, a database management system and “device drivers” for allowing processor 210 to interface with computer peripheral devices. Appropriate program elements are known to those skilled in the art, and need not be described in detail herein.

According to an embodiment of the present invention, the instructions of program 215 may be read into a main memory from another computer-readable medium, such as from a ROM to RAM. Execution of sequences of the instructions in program 215 causes processor 210 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Databases

Referring to FIG. 5, a table represents an employee database 300 that may be stored at controller 200 according to an embodiment of the present invention. The table includes entries identifying a number of different employees (or other individuals who are potential donors) who are identified for potential participation in an entity's charitable contribution program. In embodiments where the charitable contribution program is run by, for example, a local community organization rather than a corporation, database 300 may instead identify a number of different individuals (rather than “employees”). Each of these employees may access or interact with the system 100 via one or more user devices 110.

The table defines a number of different fields 302-312 for each of the entries. The fields specify: an employee identifier 302, an employee name 304, an operating unit 306, contact information 308, salary information 310, and prior contribution(s) 312. The information in employee database 300 may be created and updated, for example, based on information received from various sources, including, for example, a company's human resources or payroll database. The information in employee database 300 may also be based on, for example, information generated in conjunction with a charitable contribution program.

Employee identifier 302 may be, for example, an alphanumeric code associated with an individual employee who is eligible for participation in an entity's charitable contribution program. Employee identifier 302 may be assigned by the system or it may be an identifier assigned by the entity to uniquely identify the employee for human resources or payroll matters.

Other information identifying the employee is also included, including an employee name 304, information identifying the operating unit 306 in which the employee works or is associated with (such as, for example, a standardized corporate identifier for each operating unit), and employee contact information 308 (preferably including an electronic mail address and/or telephone number).

Further, in one embodiment, employee database 300 stores (or has access to) information used to generate individualized charitable contribution solicitations for each employee, including employee salary information 312 (to compute potential contribution levels) and prior contribution(s) of the employee (to remind the employee and to solicit donations of a similar or increased amount). Other information useful in particularly identifying employees and their donation profile may also be stored or accessible by employee database 300.

For example, in some embodiments, an employee may establish a password to secure his or her communications with controller 200. This password may be set in a number of different ways. For example, in some embodiments, a registration process may be used to set a password in which the employee visits a registration Web page maintained by controller 200. The employee may be prompted to enter identification information, such as employee identifier 302, and a desired password. This password information may be securely stored at controller 200. In some embodiments, the employee may also be asked to provide a hint or other personal information which may be used in the event the employee forgets his or her password.

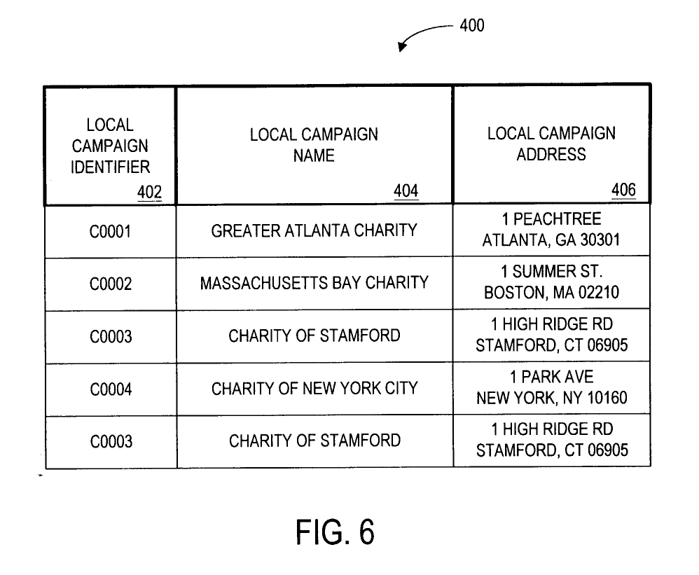

Referring now to FIG. 6, a table represents local campaign database 400 that may be stored at (or accessible to) controller 200 according to an embodiment of the present invention. The table includes entries identifying a number of different local campaigns that are a part of an overall campaign for which an entity is running a charitable contribution program. For example, an entity participating in a United Way campaign will participate in a number of local campaigns based on corporate locations.

The table also defines a number of fields 402-408 for each of the entries. The fields specify: a local campaign identifier 402, a local campaign name 404, and a local campaign address 406. The information in local campaign database 400 may be created and updated, for example, based on information received from a charitable campaign such as the United Way. The information in database 400 may also be based on, for example, a special campaign established by an entity.

Local campaign identifier 402 may be, for example, an alphanumeric code associated with a particular local campaign (or even an individual charity in a particular area or region) which has been identified as participating in the overall charitable campaign. This identifier 402 may be generated by, for example, controller 200 or it may be a unique identifier assigned by an overall charitable campaign or by the local campaign. Other information identifying the local campaign is also provided in database 400, including a name of the local campaign and an address of the local campaign. This address will be used, as will be described further below, to associate the local campaign with one or more operating units of the entity.

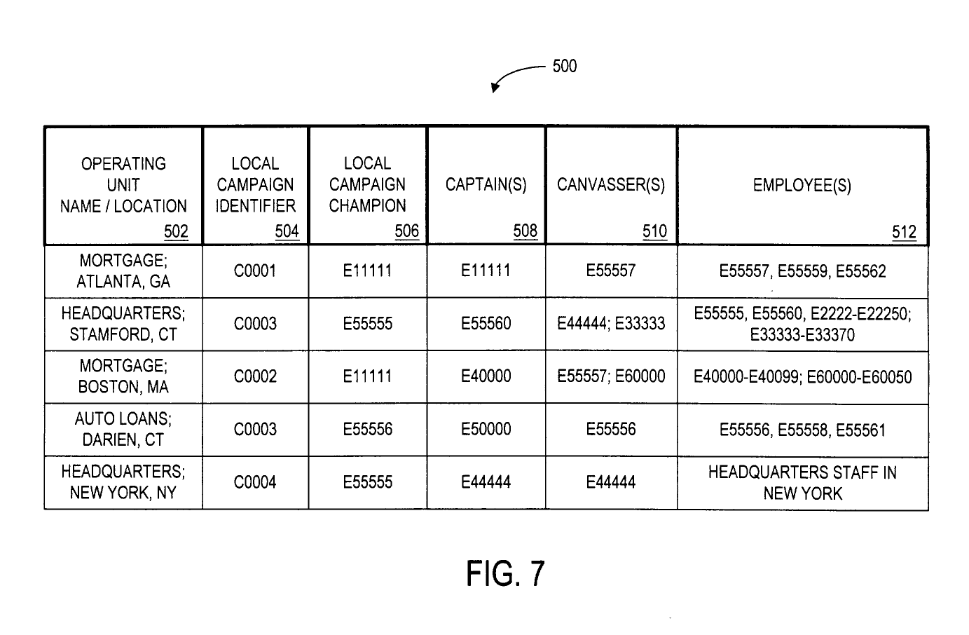

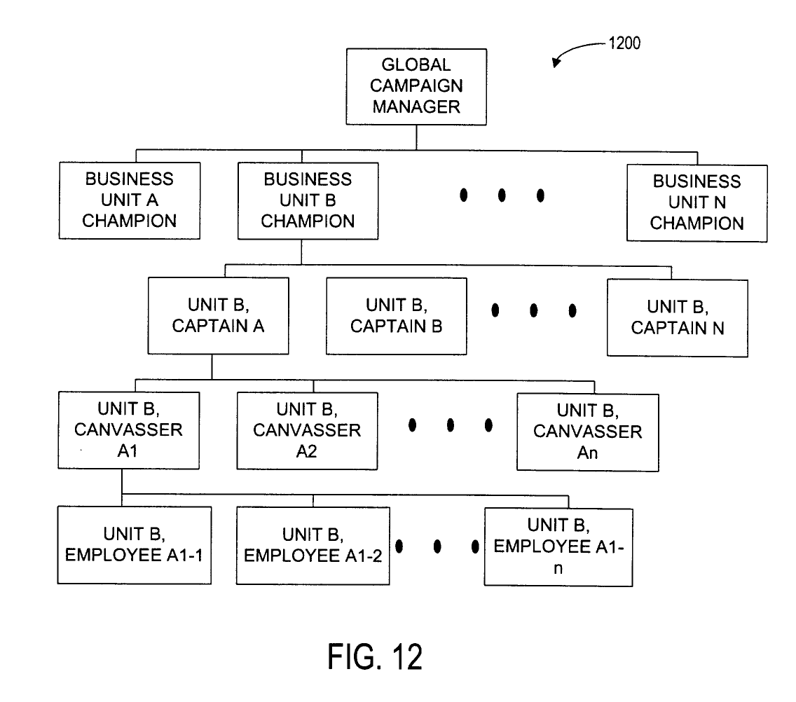

Referring to FIG. 7, a table represents campaign database 500 that may be stored at (or be accessible by) controller 200 according to an embodiment of the present invention. The table includes entries used to identify a hierarchy of a particular charitable contribution program run by an entity. The table also defines fields 502-510 for each of the entries. The fields specify: an operating unit name/location 502, a local campaign identifier 504, a local campaign champion 506, captain(s) 508, canvasser(s) 510, and employee(s) 512. Other information (such as the identification of other participants,) may also be provided but are not shown in this example. An example hierarchy 120 showing different participles is shown in FIG. 12.

The information in campaign database 500 may be created and updated, for example, based on information received from individual operating units of an entity, information from local campaign database 400, and information input by individuals charged with operating the entity's charitable contribution program. For example, an overall campaign manager may utilize embodiments of the present invention to help select and appoint local campaign champions and captains, while the local campaign champions and captains, in turn, will use embodiments of the present invention to appoint individual canvassers and associate those canvassers with individual employees.

Operating unit name/location 502 may include operating unit names and locations of each of the different operating units of an entity which will participate in the entity's charitable contribution program. This information is related to the operating unit name entered in employee database 300. According to one embodiment of the invention, local campaign identifier 502 is automatically entered in database 500 by comparing the location of each operating unit with the location of each local campaign identifier in a given charitable campaign (e.g., the “MORTGAGE” operating unit, located in “ATLANTA, “GA” is automatically identified as being in the region served by the local campaign identified by “C0001”).

Campaign champion 506 includes information identifying a particular individual or individual(s) who have been appointed as the champion for a particular operating unit. In some embodiments, information identifying an overall campaign manager may also be included in database 500. In some embodiments, each operating unit, or groups of operating units, may have a champion. In one embodiment, each champion 506 is identified by his or her employee identifier (from database 300 and/or from an entity's human resources or payroll database).

One or more captain(s) 508 are appointed to help manage a local campaign. These captain(s) 508 may be identified by their employee identifiers or other information uniquely identifying them. Captain(s) 508 may be appointed by a campaign champion or other authorized individual operating the system of the invention.

Similarly, one or more canvasser(s) 510 are also identified by their employee identifiers or by other information uniquely identifying them. These canvasser(s) 510 are selected by individual operating units and/or campaign captains of individual operating units to actively solicit contributions from employees 512 at each individual operating unit. The individual employees associated with each canvasser 510 are identified in field 512 (again, in one embodiment, by their employee identifiers or other information uniquely identifying them). In one embodiment, each canvasser 510 is assigned to solicit donations from one or more employees 512. The employees assigned to each canvasser 510 may be automatically allocated by the system or may be assigned to each canvasser by captain 508.

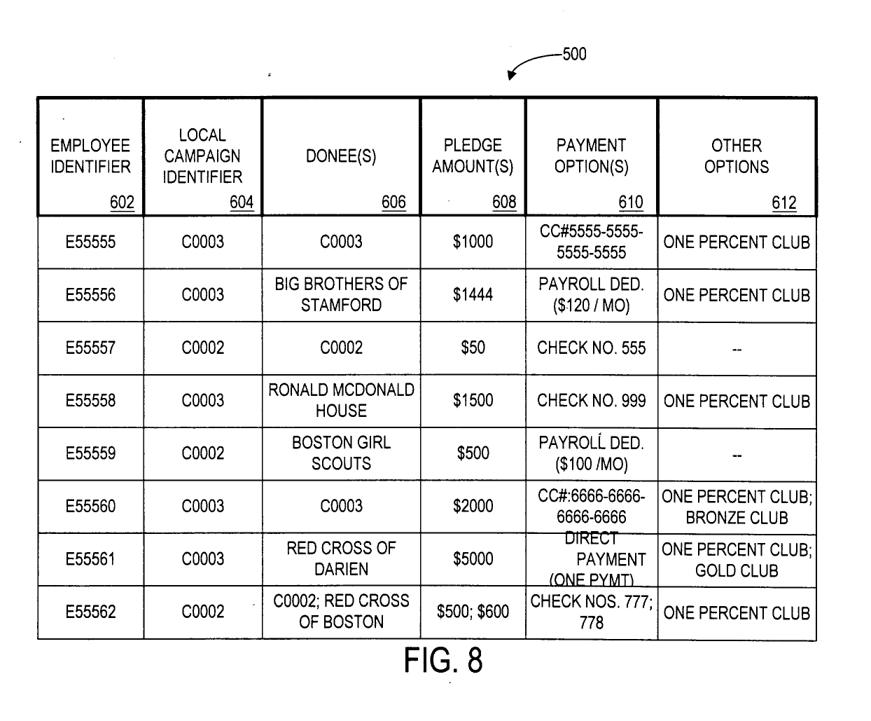

Referring to FIG. 8, a table represents donation database 600 that may be stored at controller 200 according to an embodiment of the present invention. The table includes entries identifying a number of individual pledges or donations which have been generated by the charitable contribution program of the present invention for a particular entity. The table defines fields 602-612 for each of the entries. The fields specify: an employee identifier 602, a local campaign identifier 604, donee(s) 606, pledge amount(s) 608, payment option(s) 610, and other options 612.

The information in donation database 600 may be created and updated, for example, based on information received from individual employees (donors) during the course of a charitable contribution program. According to the invention, individual employees submit donation information using information screens which will be discussed below. This donation information is used, as will be described further below, to settle with individual charities and to track corporate donation information.

Employee identifier 602 is an identifier identifying a particular employee who has made one or more donations using the system of the present invention, and is preferably based on or the same as the employee identifier 302 of employee database 300. Local campaign identifier 604 is an identifier identifying a particular local campaign in which the employee identified by employee identifier 602 participated. This identifier is preferably based, on or the same as, the local campaign identifier 402 of database 400.

Donee(s) 606 is one or more identifiers identifying a target donee to which the employee identified by employee identifier 602 has pledged to make a donation. The donee may be identified by its federal tax identifier, by its name and address, or by other information used to uniquely identify individual donees. In one embodiment, employees may designate a local campaign (such as the local campaign identified by local campaign identifier 604) as the entity receiving a donation. In one embodiment, options regarding potential donees may be presented to an employee via a drop-down listing viewable via a Web-browser. Employees may also elect to write in a donee organization.

Pledge amount(s) 608 is information identifying an amount or amounts which the employee has pledged to each donee. Payment option(s) 610 include information identifying a particular payment option selected by the employee identified by employee identifier 602 in making a donation to donee(s) 606. Example payment options which may be supported include: payroll deduction; check; credit card; stock; etc.

Other information used to particularly identify or characterize a particular donation may be provided in other options 612, which may include, for example, information identifying special recognition to be accorded to individual employees (e.g., an entity may establish different levels of recognition for different levels of donation, such as for example a “BRONZE CLUB” for donations between $1500 and $2499, etc.). Other options 612 may also include information supplied by the employee making the donation indicating the employee's preference to be included (or not included) in one or more directory listings of donors. Those skilled in the art will recognize that other information may be collected and provided to further identify donations.

Process

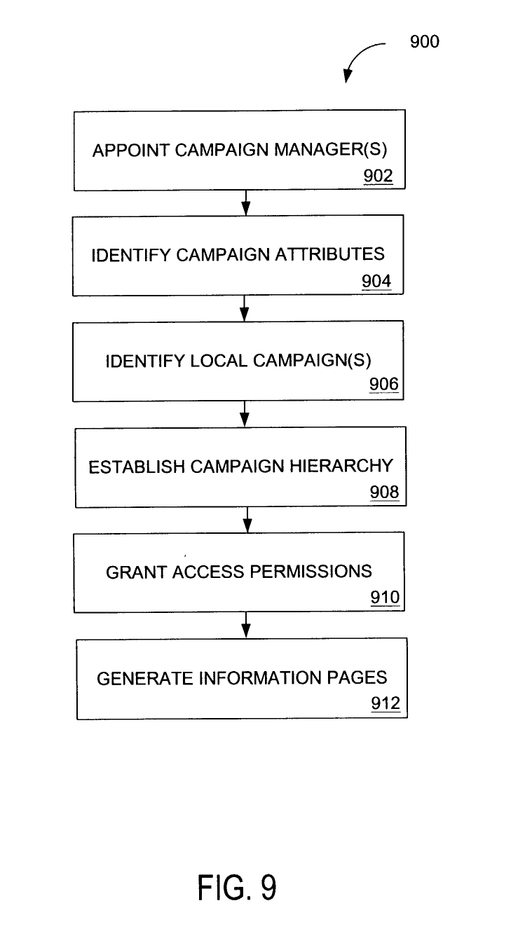

Embodiments of the present invention will now be further described by referring to FIG. 9, where a process 900 is shown for defining and establishing a charitable contribution program according to one embodiment of the present invention. Process 900 begins at 902 where a global campaign manager and one or more champions for a particular charitable campaign are appointed. An entity operating the system of the present invention to run a corporate charitable contribution program may support one or more charitable campaigns. Preferably, at least one campaign manager is appointed at 902 for each campaign. Each charitable campaign (such as, for example, the 2001 United Way Campaign, or the 2001 Combined Federal Campaign) may include a number of local campaigns as well. The system of the present invention may be used to manage each of these local campaigns as will be described below.

Processing continues at 904 where system 100 (of FIG. 2) is operated to first identify attributes of a charitable campaign. In one embodiment, this is performed by the global campaign manager appointed at 902. In particular, the global campaign manager may interact with the system 100 to define and identify attributes of the charitable campaign for which the global campaign manager is responsible. Various attributes may be identified, including, for example, the particular charitable campaign that will be supported (such as, for example, the United Way, the Combined Federal Campaign), the entity's objectives for the campaign, etc.

A charitable campaign may include one or more local charitable campaigns, each of which is managed using embodiments of the present invention. At 906, a global campaign manager along with champions, interacting with the system of the present invention, selects one or more local campaigns which will be a part of the overall campaign. Start and end dates of each local campaign may also be established. Other program attributes may also be established, including, for example, a definition of the different operating units of the entity which will be participating in the program. In some embodiments, the global campaign manager is given the authority to add new campaigns to the system.

In one embodiment, a listing of local campaign(s) included in a particular charitable campaign is stored at controller 200 (e.g., stored as database 400 of FIG. 6). Preferably, information particularly identifying the different local campaigns which will be a part of the charitable contribution program are stored or otherwise made available to controller 200. For example, different local campaigns may be identified by their name and address. In one embodiment, the association of local campaign(s) is done in an automated fashion by comparing geographical information about different local campaigns with geographical information about operating units of the entity.

Processing continues at 908 where a hierarchy of the charitable campaign is established to identify roles of various participants at an entity, including champions, captains, canvassers, and potential donors. For example, processing at this stage may include the appointment of a champion, one or more captains, and one or more canvassers for a particular campaign, as well as identifying those employees of an entity who will be participating in the campaign. An illustrative example of a hierarchy 1200 is shown in FIG. 12. In one embodiment, each individual in a hierarchy are identified by their employee identifiers (e.g., set forth in employee database 300 of FIG. 5). Information reflecting the hierarchy which is established may be stored, for example, at controller 200 in campaign database 500 (FIG. 7).

The number and identity of each of these individuals depends on the nature of the entity and the campaign (e.g., a company-wide campaign for a large company with a number of different operating units may require many captains each responsible for a large number of canvassers who are in turn responsible for a number of employees). In some embodiments, the appointment of each of the individuals is facilitated using features of the present invention. For example, in some embodiments, each employee of the entity is included in an employee database which is accessible by controller 200. This employee information is used to assist in the establishment of a charitable campaign hierarchy.

For example, to establish a hierarchy, the global campaign manager may interact with data input screens generated by controller to select and appoint individuals as champions, etc. In some embodiments, the global campaign manager interacts with controller 200 to first select one or more individuals as champions for a particular charitable campaign. The global campaign manager may then utilize the system to review, edit and otherwise maintain the list of champions. The global campaign manager (or the champions), may then interact with controller 200 to select individual employees to serve the function of captains reporting to particular champions.

This process may then be repeated to select canvassers reporting to particular captains. Finally, donors are associated with individual canvassers. Each of these associations and identifications may be performed using employee data retrieved from an existing employee database (e.g., such as an employee database maintained by the entity's human resources or payroll department). Groups of employees may be identified by their operating location or division. This allows the appointment of a canvasser who is co-located or otherwise familiar with a particular group of donors. By using data from existing employee databases, in some embodiments, employee donations may be submitted via the entity's existing payroll system (if such a form of contribution is selected by the employee).

Processing continues at 910 where access permissions are granted to each of the individuals in the hierarchy. These access permissions permit (or deny) individuals access to various functions of system 100 of FIG. 2. For example, a champion is preferably given greater access to system 100 than a captain, who is given greater access than a canvasser, who is given greater access than a potential donor. These permissions may be enforced and controlled using password protection and other techniques generally known to those skilled in the art.

A network administrator or other individual may assign these permissions to various individuals at 910. Generally, the global campaign manager will be given the highest level of permissions, allowing the global campaign manager to access the greatest amount of detail and information about the charitable contribution program. For example, the global campaign manager may be given the authority to send messages to every other individual (or selective groups or individuals) in the hierarchy (e.g., the champions, the captains, the canvassers and the donors). Further, the global campaign manager may be given the authority to generate a number of different reports, set up the overall campaign, establish and maintain the hierarchy, and perform other administrative and managerial functions to manage the campaign. Champions may be given slightly less authority, but sufficient to allow them to manage the campaign for their particular operating unit. Captains will have less authority, allowing them to manage the canvassers appointed to them. Canvassers will have less authority still, allowing them to communicate with and solicit donations from the donors appointed to them.

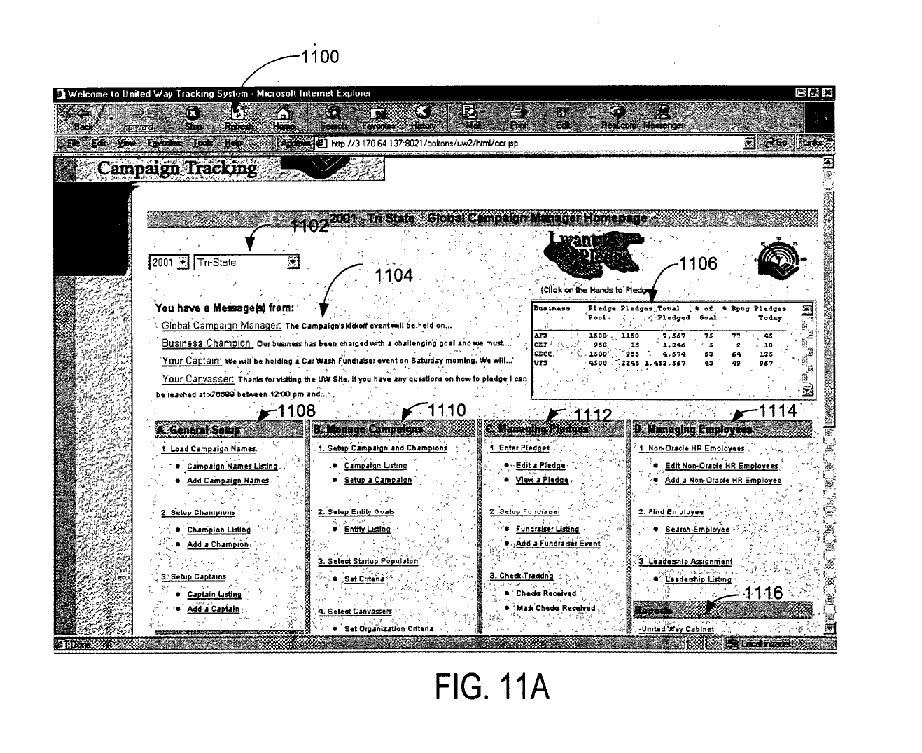

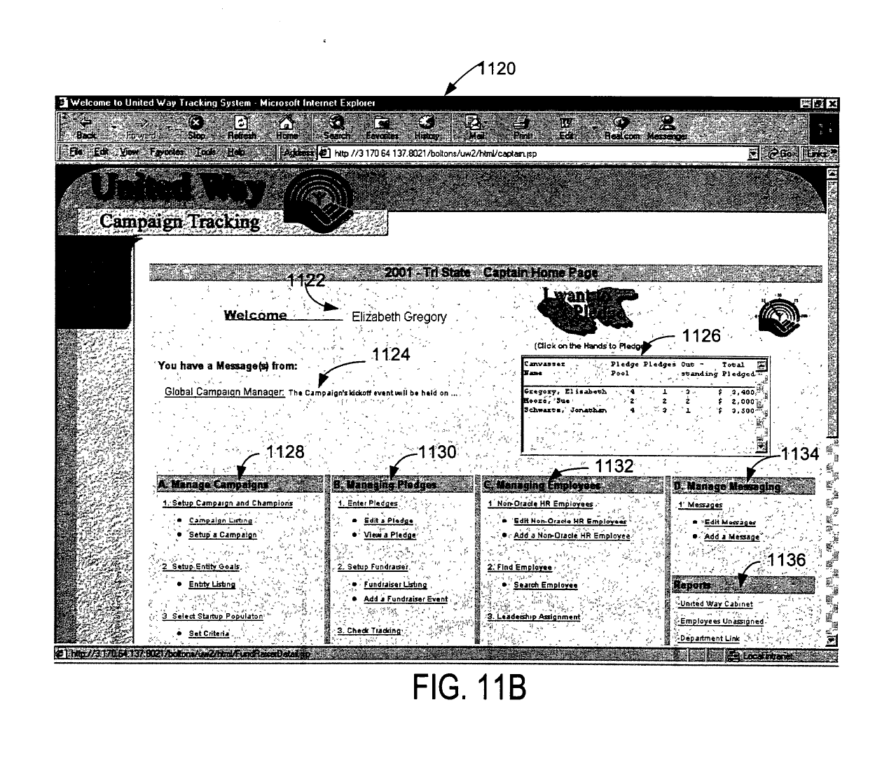

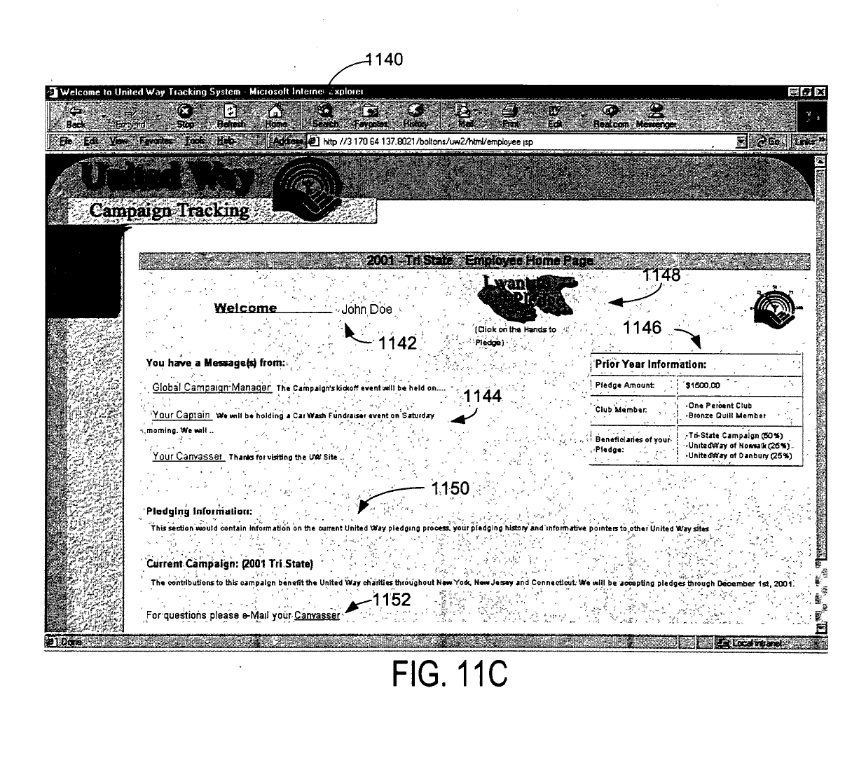

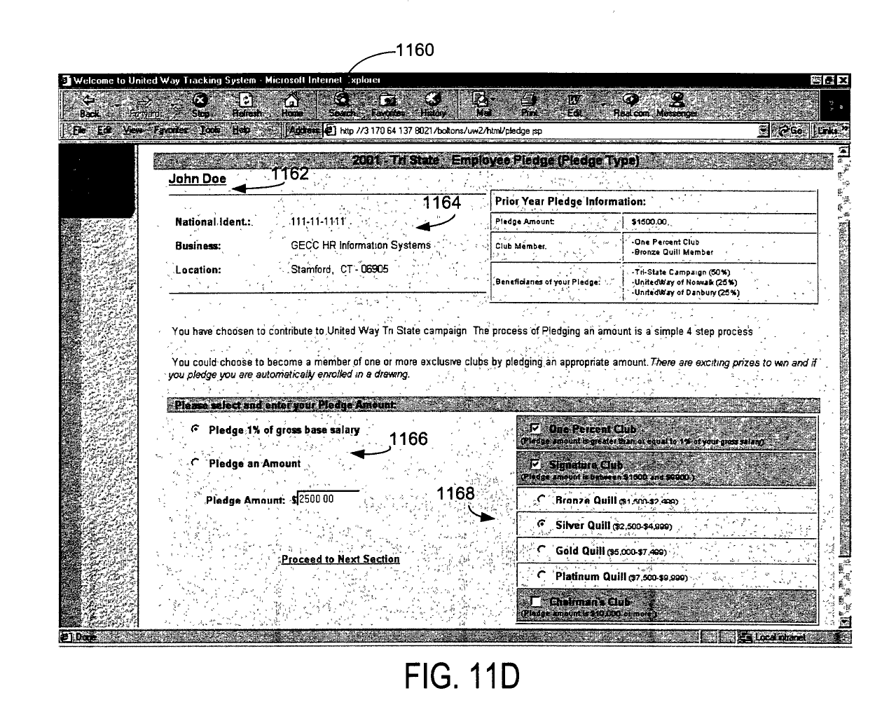

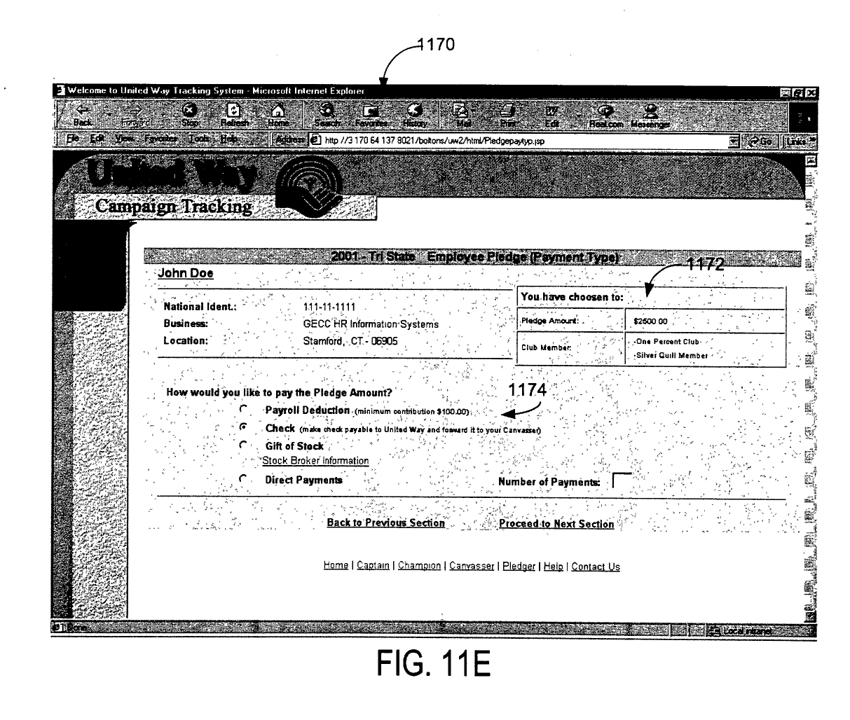

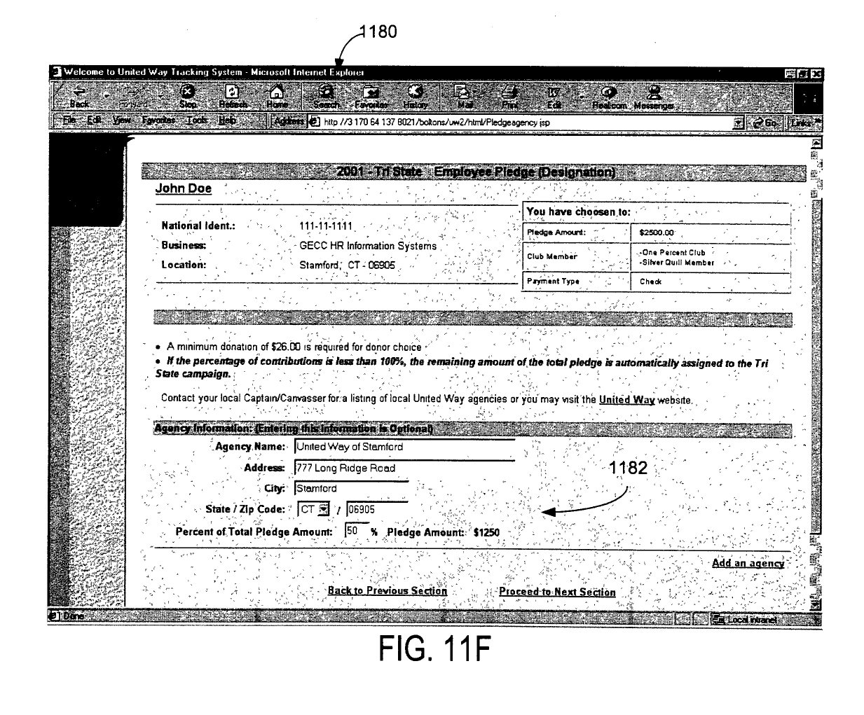

Information regarding the charitable contribution program will be generated for individuals in the hierarchy at 912. This information is presented, in one embodiment, via a set of information pages or screens which are viewable by individual participants and managers operating user devices 110 (FIG. 2). These information screens will be described further below in conjunction with FIG. 11.

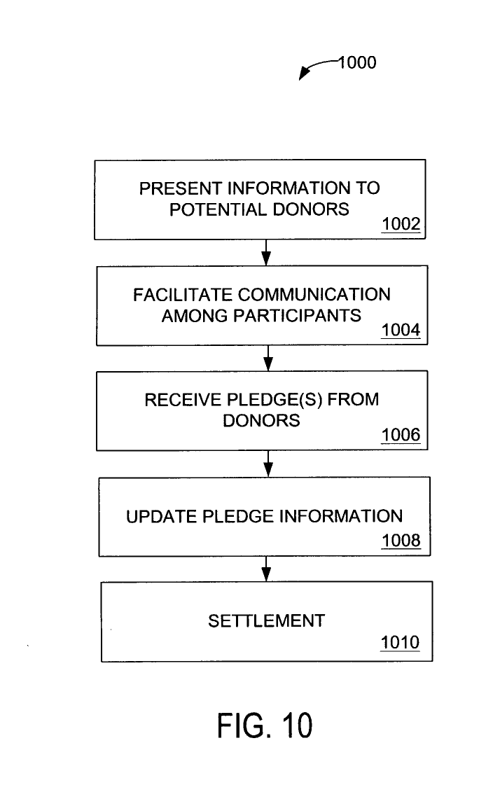

Referring now to FIG. 10, a process 1000 for conducting a charitable contribution program according to one embodiment of the invention is shown. This process 1000 is conducted at the completion of process 900 (FIG. 9), once a particular campaign has been established. Process 1000 begins at 1002 where information soliciting donations is transmitted and presented to potential donors. According to one embodiment of the present invention, system 100 is used to electronically transmit and present solicitation information to individual employees or other potential donors. This information may be repeatedly transmitted to potential donors until the campaign is complete and/or until the potential donor makes a donation.

Processing continues at 1004 where system 100 is used to facilitate communication among participants. In one embodiment, this is accomplished through use of the hierarchy established above, where individual participants are granted particular access permissions and privileges. Individual participants may be granted access to one or more information pages tailored to them and including information directed to them. Global campaign managers and champions have access to information pages having detailed information about the status of the campaign. Captains have access to information pages providing the status of the performance of employees and canvassers assigned to that captain. According to the invention, each information page also provides messaging capabilities to facilitate communication between participants. Examples and features of information pages will be provided below in conjunction with FIG. 11.

Processing continues at 1006 where pledge(s) are received from individual donors. According to embodiments of the invention, pledges may be submitted from individual employees or other donors via information pages created and presented by system 100. Example pledge information pages will be described below in conjunction with FIG. 11. According to embodiments of the invention, this pledge information may be received and used to update information about the charitable campaign at 1008. This pledge information may be stored, for example, in pledge database 600 (FIG. 8). This updating of pledge information may be performed in near real-time, allowing entities using features of the invention to easily monitor the status of their charitable contribution programs at any point in time and at many levels. Because this information may be updated in near real-time, a number of detailed reports may be generated to provide insight into the campaign.

Processing continues at 1010 where one or more batch processes are performed to settle donations and follow up with pledges. This step may be performed on a regular basis or at the end of a campaign. In one embodiment, individual canvassers, captains, and champions may follow-up with pledges which have been made by employees but which have not been funded by the employee. Processing at 1010 may include the transmission of data to charities and campaign organizers (e.g., monthly and campaign-end summaries of pledges are typically transmitted from an entity to the United Way or other charitable organizations). Data may also be transmitted to other third parties such as payroll providers, authorizing the payroll provider to deduct funds from donor's payroll pursuant to pledges received from those donors. Other batch processes to ensure that funds are committed to charities as designed by individual donors may also be performed by the system.

User Interface Examples

Referring now to FIGS. 11A-F, a number of example user interfaces are shown. These examples are presented to illustrate one type of interface that may be used to solicit, collect and report donations using embodiments of the present invention. Those skilled in the art, upon reading this disclosure, will recognize that a variety of types and forms of user interfaces may be used. Referring first to FIG. 11A, which is an outward view of a global campaign manager user interface 1100 according to an embodiment of the present invention. As shown, global campaign manager user interface 1100 is presented as a Web page within a window of an executing Web browser application.

Global campaign manager user interface 1100 depicts an information screen which is generated for an individual who has been appointed “global campaign manager” (as described above) for a particular charitable campaign of an entity. As discussed above, the global campaign manager (as well as other participants) is given specific access permissions or privileges. As a result, an information screen generated for the global campaign manager is only accessible to the individual with the global campaign manager's access permissions. Password protection and user identification techniques known in the art may be used to enforce these permissions.

In one embodiment, the global campaign manager user interface 1100 is used to implement many of the program definition activities discussed above in conjunction with FIG. 1 and FIG. 9. Global campaign manager user interface 1100 is also used to provide reports and up-to-date data and information to the global campaign manager.

In the example global campaign manager user interface 1100, reports, data and information about a campaign is accessible to the global campaign manager via items 1102, 1104, 1106, and 1116. In the example shown, the particular charitable campaign which is being supported is the 2001 United Way. The local campaign is identified by box 1102 (in this case, the local campaign is the “2001 TRI-STATE”). A message section 1104 presents messages directed from the global campaign manager to one or more champions, captains or canvassers, to subordinates in the campaign hierarchy (e.g., individual canvassers, captains, champions, all employees within a business or in a location, captains, or every employee).

A status section 1106 presents status information regarding the current status of the campaign (preferably substantially in real time). In one embodiment, this status may be presented for the overall campaign (here, the entity's participation in the 2001 United Way campaign) or for one or more local campaigns (e.g., as depicted in FIG. 11A, the status given in status section 1106 is for the entity's participation in the “2001 TRI-STATE” local campaign). Various reports are available to the global campaign manager via report section 1116.

Program definition and management activities are accessible to the global campaign manager via a setup section 1108, a campaign management section 1110, a pledge management section 1112, and an employee management section 1114. Setup section 1108 provides various options available to the individual given the access permissions and privileges of a global campaign manager, including the ability to review a list of campaign names and also the ability to add new campaign names (in particular, global campaign managers can be given the ability to add local campaign names to a particular campaign).

Setup section 1108 also allows authorized global campaign managers to set up a management hierarchy for one or more campaigns. In particular, the global campaign manager may appoint one or more champions or champions using setup section 1108. These local campaign managers may be selected from a listing such as an employee listing from an employee database such as database 300 of FIG. 5. In one embodiment, each local campaign is established with one champion.

Setup section 1108 also allows authorized global campaign managers to appoint one or more captains to a local campaign. These captains may be selected from a listing such as the employee database 300 of FIG. 5. Each captain appointed by a global campaign manager will be given access permissions and privileges allowing the captain to access one or more captain user interfaces (discussed below in conjunction with FIG. 11B).

Campaign management section 1110 provides various options to help a global campaign manager manage a charitable campaign. In some campaigns, some of these campaign management activities may be delegated to one or more champions. Campaign management section 1110 allows an individual with appropriate access permissions and privileges to set up a campaign (e.g., by selecting from a listing of local campaigns and associating each local campaign with one or more champions). As discussed above, local campaigns may be selected from local campaign database 400 shown in FIG. 6, and champions and captains may be selected from employee database 300 (shown in FIG. 5). A global campaign manager may also be given the ability to modify a Web page used as the “home page” for the charitable campaign. This allows the global campaign manager to provide up-to-date information regarding the campaign to employees and other visitors to the home page.

Campaign management section 1110 also allows a global campaign manager (and in some situations a campaign captain or champion) to establish one or more entity goals for the charitable campaign. Different goals may be established for different operating units of an entity. These goals may include, for example, total charitable donation goals for each operating unit participating in the charitable campaign or donation goals for a subset of the operating unit such as one location. Section 1110 also allows a global campaign manager or other authorized individual to select a target population of potential donors. This target population may be selected from employee database 300 (FIG. 5) or some other database listing employees of an entity. In one embodiment, this target population may be selected based on certain criteria which may be established by the global campaign manager through section 1110. For example, a global campaign manager, through section 1110, may indicate that employees working in offices located in New York, Connecticut, and New Jersey are the target population for the local campaign referred to as the “2001 TriState Campaign”.

Section 1110 also allows a global campaign manager or other authorized individual to select one or more canvassers to solicit donations from the target population of potential donors. Section 1110 allows the establishment of criteria upon which to select these canvassers. For example, the campaign manager, captain or champion, may wish to select only individuals who were not canvassers during the previous campaign. Other criteria may also be applied to select and appoint these canvassers for each local campaign.

Pledge management section 1112 allows an authorized individual such as a global campaign manager to perform certain activities to manage individual pledges made by employees. For example, through section 1112, an authorized individual may view individual pledges (e.g., pledges stored in donation database 600 described above) and then edit one or more features of the pledge (e.g., the amount, payment method, donee, etc.). This allows the global campaign manager to respond to employee requests to correct or amend pledges after the pledge has been formally submitted by the employee.

Individual fundraising events may also be managed through pledge management section 1112. For example, this will allow individuals such as the global campaign manager, champions or captains to run targeted fundraising events during the course of a larger campaign. A captain responsible for an operating unit which is lagging in contributions may decide to establish and manage a special fundraising event to encourage increased contributions. Access to features through pledge management section 1112 allows the captain to establish and manage such a fundraising event. Notice of the fundraising event will be sent to only those individuals for whom the captain is responsible.

Pledge management section 1112 also allows authorized individuals to monitor payments of pledges, such as, for example, the status of checks received. This, allows captains or others to follow up with individuals whose checks have not been received within a reasonable period of time to ensure that pledges are actually made.

Employee management section 1114 allows authorized individuals to add or edit employees or other potential donors who are not part of employee database 300 (or other company databases such as the human resources database or payroll database). Preferably, the ability to edit or otherwise modify pledges is given only to high level participants such as the global campaign manager and champions. Section 1114 also provides access to tools allowing authorized individuals to search for particular employees or other individuals.

Report section 1116 provides access to various reports and other data screens providing authorized individuals with detailed, up to date information about the charitable campaign. In one embodiment, a number of pre-established reports are available with data updated on a near real-time basis. Custom reports are also available to authorized individuals such as global campaign managers and captains. A variety of types of reports may be made available to authorized users, including, for example: a list of employees who have not yet been assigned to canvassers; a list of participating operating units; a list of individuals in the hierarchy (e.g., campaign manager, champions, captains, canvassers, etc.); a list of employees in the campaign; a list of canvassers and their employees; a summary of pledges by operating unit; performance vs. goals; one-percent donors; donors via check; employees already pledged; employees who have not pledged; a list of matching contributions; summary by operating unit; summaries by location, gift histories by location or operating unit, etc.

Referring now to FIG. 11B, a captain user interface 1120 is shown. This captain user interface is an example of an information screen which may be generated and updated throughout a campaign and accessible by individuals appointed as captains in the campaign. As discussed above, the campaign manager may appoint individuals to the status of captain through use of campaign manager user interface 1100. The particular captain for whom this particular interface has been generated is shown as identifier 1122.

Captain user interface 1120 has similar sections as the global campaign manager user interface 1100, including a message section 1124, a status section 1126, a campaign management section 1128, a pledge management section 1130, an employee management section 1132, and a report section 1134. These sections provide similar functionality as the sections described in conjunction with FIG. 11A, above, allowing authorized individuals to perform selected tasks to operate a campaign. The status section 1126 for a captain may include a different level of information than the status section for the global campaign manager. For example, a captain may be presented with status information regarding the status of canvassers reporting to the captain.

Further, a messaging section 1136 is also provided. Messaging section 1136 allows the captain interacting with captain user interface 1120 to quickly and easily communicate with individuals in the campaign hierarchy, including the campaign manager, champions, canvassers reporting to the captain, and employees associated with each of the canvassers. Similar information screens can be generated for other participants, including champions, and individual canvassers.

Referring now to FIG. 11C, an example employee user interface 1140 is shown. Employee user interface 1140 is personalized for the employee identified in employee field 1142, and is only accessible to that employee. An employee may access the information screen by pointing his or her Web-browser to a Web page on a corporate intranet, for example. Each employee may receive the address of his or her employee user interface in an introductory e-mail, letter, memo, voice mail, or other correspondence which is sent to the employee from the global campaign manager or other individual at the start of a charitable campaign. The information is preferably securely presented to the employee using techniques known to those skilled in the art.

Employee user interface 1140 has a number of elements, including employee field 1142 which identifies the employee for whom the user interface has been created. A message section 1144 is provided which displays messages received by the employee from the global campaign manager and/or the employee's champion, captain and canvasser. These messages are used by the other participants to actively solicit and encourage employees to participate in the campaign and to inform the employees of activities of interest, such as fundraising events or the like.

A pledge history section 1146 is provided which reminds the employee of prior year or prior campaign participation, encouraging the employee to contribute at a similar or increased level. A pledge button 1148 is provided to allow the employee to quickly and easily indicate his or her desire to make a pledge in the current campaign.

An information section 1150 is provided which contains information describing the current campaign. A messaging section 1152 includes one or more links which quickly allow the employee to communicate with his or her canvasser and/or other participants in the campaign. This allows the employee to easily communicate with individuals who are responsible for that particular employee, without having to search through a telephone book or address book to find the appropriate individual.

An employee who wishes to make a pledge indicates this desire by interacting with pledge button 1148 which takes the employee to another employee user interface 1160. This employee user interface 1160 is shown in FIG. 11D. This interface 1160 includes a number of sections including an employee identifier 1162. A local campaign identifier 1164 provides information identifying the operating unit to which the employee is assigned and further identifies the local charitable campaign in which that operating unit is participating.

A pledge section 1166 includes one or more options allowing the employee to pledge an amount of money to a designated charity. In one embodiment, the employee is given the option of pledging a flat percentage of his or her income (the employee's income information is preferably retrieved from employee database 300 of FIG. 5). The employee may also be given the option of pledging any amount desired by the employee. Other options are contained in club section 1168 which allows the employee to join one or more pledge clubs which may make the employee eligible for further recognition. Once the employee has designated an amount and/or a club level at which the employee would like to pledge, the employee is taken to the next screen, an example of which is shown in FIG. 11E as employee user interface 1170.

Employee user interface 1170 includes a number of information areas, including a confirmation section 1172 which reiterates the pledge amount and/or club level(s) that the employee will be participating in. Payment section 1174 provides the employee with one or more options regarding payment for the pledge amount. Any of a number of different payment devices may be used, including for example, payroll deduction, check, stock, direct payments, and credit card payments. Once the employee has selected his or her desired payment option, the employee is taken to employee user interface 1180, an example of which is shown in FIG. 11F.

Employee user interface 1180 includes information reiterating the employee's choices regarding amount and payment type, and provides the employee with a donor choice section 1182 where the employee may enter in information identifying a selected charity (or charities) which should receive his or her donation. In one embodiment, the employee types this information into appropriate form fields on interface 1180. In other embodiments, the employee may select from a drop-down list or check list of available charities. Upon completion of this information, the employee may submit the finalized pledge to system 100. The employee may receive a confirmation message which the employee may print out for his or her records. In some embodiments, employees may receive special recognition in the form of e-mail coupons or certificates thanking the employee for his or her participation. Once the pledge has been submitted by the employee, information at controller 200 (FIG. 2) is updated, allowing authorized managers (such as campaign managers, captains, and other designated individuals) access to updated, near real-time pledge information. This information may be presented in a variety of reports and will further expedite the delivery of the actual sums pledged to the recipient organizations. For example, a campaign data and matching gift report can be generated to stimulate accounts payable to generate corporate “matching” contribution checks to the charitable entities in the locations where employees participated in the charitable campaigns. Further, an example of another aspect of “final” reports is that by which the organizations payroll system will be stimulated to generate payroll deductions to satisfy pledge commitments.

Although the present invention has been described with respect to a preferred embodiment thereof, those skilled in the art will note that various substitutions may be made to those embodiments described herein without departing from the spirit and scope of the present invention. For example, in some embodiments, “fundraiser” events may be established and managed using features of the present invention. Fundraisers are used within charitable contribution campaigns to raise awareness and push for greater participation in the campaign. Examples of different types of fundraisers are carwashes, bake sales, etc. Embodiments of the present invention may be used to create a fundraising event and communicate details of the fundraiser event to selected individuals in the campaign hierarchy. For example, a fundraiser to be held by a particular group within an operating unit may be organized by a captain responsible for the particular group. The captain, interacting with controller 200, may define details of the fundraiser (e.g., the dates of the event, the goal amount, etc.). Details of the fundraiser may then be communicated to each canvasser and each donor associated with the captain. These details, for example, may be automatically transmitted to user interfaces associated with each of the relevant individuals.

What is claimed is:

1. A method for structuring an automated charitable contribution program at an entity consisting of a plurality of operating units, the method comprising:
establishing a program hierarchy including at least one campaign manager, at least one operating unit manager for each of said plurality of operating units, and at least one canvasser reporting to each of said operating unit managers;
retrieving information identifying a plurality of potential donors;
associating each of said potential donors with a canvasser; and
generating an information screen for each of said potential donors.

2. The method of claim 1, wherein said program hierarchy further includes at least one intermediate level manager beneath one of said operating unit managers in said program hierarchy.

3. The method of claim 1, wherein said establishing a program hierarchy further comprises:
identifying a plurality of individuals associated with each of said operating units; and
selecting at least one of said individuals as an operating unit manager for each of said operating units.

4. The method of claim 1, further comprising:
associating each of said operating units with at least one local campaign.

5. The method of claim 4, wherein said associating further comprises:
determining a location of each of said operating units and identifying the local campaign associated with said location.

6. The method of claim 1, wherein said establishing a program hierarchy further comprises:
assigning system access privilege levels to each of said campaign manager, said operating unit managers and said canvassers.

7. The method of claim 1, wherein said plurality of operating units are operating units of a corporation.

8. The method of claim 1, further comprising:
generating a canvasser information screen for each of said canvassers; and
generating an operating unit manager information screen for each of said operating unit managers.

9. The method of claim 8, wherein said canvasser information screen facilitates communication between said canvasser, said potential donors associated with said canvasser, said operating unit managers, and said campaign manager.

10. The method of claim 8, wherein said campaign manager information screen facilitates communication between said campaign manager, each of said operating unit managers, each of said canvassers, and each of said potential donors.

11. The method of claim 2, further comprising:
generating a manager information screen for each of said intermediate level managers, said manager information screen facilitating communication between said intermediate level manager, said campaign manager, said operating unit managers, a plurality of canvassers reporting to said intermediate level manager, and each of said potential donors.

12. A method for conducting an automated charitable contribution program in an entity having a number of operating units, comprising:
transmitting donation solicitation information to a plurality of potential donors at each of said operating units;
receiving donation information from at least one of said plurality of potential donors; and
updating, substantially in real time in response to said receiving donation information, a pledge database.

13. The method of claim 12, wherein said transmitting donation solicitation information comprises:
generating an electronic interface for each of said potential donors, said electronic interface presenting information including said donation solicitation information, said electronic interface facilitating communication between said potential donor and a canvasser assigned to said potential donor.

14. The method of claim 13, wherein said electronic interface further includes:
information identifying an amount of a previous donation by said potential donor;
information identifying a status of the charitable contribution program; and
information identifying donation options of said potential donor.

15. The method of claim 13, wherein said electronic interface further facilitates communication between said potential donor and a campaign manager.

16. The method of claim 13, further comprising:
identifying a location of each of said plurality of operating units; and
associating, based on said location, each of said plurality of operating units with a local campaign.

17. The method of claim 16, further comprising:
presenting information identifying said local campaign to said potential donor using said electronic interface.

18. A charitable contribution apparatus, comprising:
(a) a processor;
(b) a communications device, in communication with said processor, receiving data; and
(c) a memory unit in communication with the processor and storing a program, wherein the processor is operative with the program to
(i) establish a program hierarchy including at least one campaign manager, at least one operating unit manager for each operating unit of an entity, and at least one canvasser, said canvassers each reporting to one of said operating unit managers;
(ii) retrieve information identifying a plurality of potential donors;
(iii) associate each of said potential donors with a canvasser; and
(iv) generate a charitable donation information screen for each of said potential donors.

19. The apparatus of claim 18, wherein said charitable donation information screen facilitates communication between each of said potential donors and their respective canvasser, operating unit manager, and campaign manager.

20. A computer-readable medium having computer-executable instructions for performing steps comprising:
(a) establishing a charitable donation program hierarchy including a campaign manager, an operating unit manager, an intermediate level manager reporting to said operating unit manager, and a plurality of canvassers reporting to said intermediate level manger;
(b) retrieving information identifying a plurality of potential donors;
(c) associating each of said potential donors with one of said canvassers; and
(d) generating an information screen for each of said potential donors.

21. A charitable contribution system, comprising:
means for establishing a charitable donation program hierarchy including a campaign manager, an operating unit manager, an intermediate level manager reporting to said operating unit manager, and a plurality of canvassers reporting to said intermediate level manger;
means for retrieving information identifying a plurality of potential donors;
means for associating each of said potential donors with one of said canvassers; and
means for generating an information screen for each of said potential donors.

22. A computer-implemented charitable contribution method, comprising:
establishing a program hierarchy including at least one campaign manager, a plurality of operating unit managers, at least one intermediate level manager reporting to each of said operating unit managers, and at least one canvasser reporting to each of said intermediate level managers;
retrieving information identifying a plurality of potential donors;
associating each of said potential donors with one of said canvassers, said associating based at least in part on an operating unit with which each potential donor is assigned; and
generating an information screen for each of said potential donors, said information screen facilitating communication between each of said potential donors, said information screen further facilitating electronic submission of donation information.
